(19) United States
(12) Patent Application Publication
(10) Pub. No.: US 2018/0035707 A1
(43) Pub. Date: Feb. 8, 2018

(54) A CLEANING UNIT

(71) Applicant: INTERNATIONAL TOBACCO MACHINERY POLAND SPOLKA Z OGRANICZONA ODPOWIEDZIALNOSCIA, Radom (PL)

(72) Inventors: Leszek SIKORA, Radom (PL); Bartosz CIESLIKOWSKI, Przysucha (PL); Radoslaw FIGARSKI, Odechowiec (PL)

(21) Appl. No.: 15/555,070

(22) PCT Filed: Mar. 1, 2016
(86) PCT No.: PCT/EP2016/054307

§ 371 Date: Aug. 31, 2017

(30) Foreign Application Priority Data
Mar. 4, 2015 (PL) P.411447
Feb. 12, 2016 (PL) P.416114

(51) Int. Cl. A24D 3/02; B08B 5/04

(52) U.S. Cl. CPC A24D 3/0225; B08B 5/04

(57) ABSTRACT

A cleaning unit for machines used in tobacco industry, configured to remove contaminations of a loose material from rod-like elements (S1, S2) arranged in a moving train (ST2), the train (ST2) comprising rod-like elements (S1, S2) separated with spaces (43) filled with the loose material, the train (ST2) being partially wrapped by a wrapper (101), wherein the cleaning unit comprises at least one suction nozzle (55, 89) for collecting the contaminations of the loose material, characterized in that the cleaning unit further comprises a shifting mechanism configured to shift covering elements (52, 64, 84, 85′, 85″, 91) to positions in which the covering elements (52, 64, 84, 85′, 85″, 91) at least partially cover spaces (43) filled with the loose material between the rod-like elements (S1, S2) during the movement of the train (ST2) in a vicinity of the suction nozzle (55, 89).

### TECHNICAL FIELD

The present disclosure relates to a cleaning unit, designed for removing contaminations from a train of rod-like elements, for use in tobacco industry machines.

### BACKGROUND

Tobacco industry products, such as cigarettes, may comprise segment filters with various filtering materials, such as activated charcoal in a form of a loose granulate located between other segments having a solid form. The segment with activated charcoal can be formed by placing the charcoal between the solid segments, which typically have a form of rod-like elements. The solid segments may have filtering properties or non-filtering properties, for example they may comprise aromatic capsules. The manufacturers of filters comprising charcoal or other loose materials aim for placement of the portions of the loose material such that the neighboring segments are not contaminated with that material or such as to eliminate the loose particles from the solid segments before wrapping the train of segments in a wrapper.

A U.S. Pat. No. 3,482,488 discloses a device for removing contaminations from rod-like elements by means of a rotary brush. Such solution has relatively low cleaning efficiency. A significant problem is that contamination remains inside grooves formed along the edge of contact of the rod-like elements with the wrapper, because the particles of the loose material have a tendency to chock in the grooves and are difficult to be removed.

There is a need to provide a device for manufacturing multi-segment filtering rods comprising loose material, which will enable cleaning such as to not remove the loose material from the locations wherein the loose material is supplied, and which will provide high cleaning efficiency of the rod-like elements.

### SUMMARY

There is disclosed herein a cleaning unit for machines used in tobacco industry, configured to remove contaminations of a loose material from rod-like elements arranged in a moving train, the train comprising rod-like elements separated with spaces filled with the loose material, the train being partially wrapped by a wrapper, wherein the cleaning unit comprises at least one suction nozzle for collecting the contaminations of the loose material. The cleaning unit further comprises a shifting mechanism configured to shift covering elements to positions in which the covering elements at least partially cover spaces filled with the loose material between the rod-like elements during the movement of the train in a vicinity of the suction nozzle.

The shifting mechanism may comprise a wheel and the covering elements mounted around a circumference of the wheel.

The shifting mechanism may comprise a belt and the covering elements mounted on an outer surface of the belt.

The shifting mechanism may be configured to move the covering elements along an elliptical track.

The covering elements may be made of a resilient material.

The covering elements may be mounted slidably with respect to the shifting mechanism of the covering elements.

The covering elements may have a pressing surface that is permeable to air.

The covering elements may have a pressing surface that is impermeable to air.

The covering elements may have a pressing surface in a shape of a portion of a cylinder.

The covering elements may further have a surface with at least one opening for collecting the contaminations of the loose material through a duct in the covering element.

There is also disclosed a machine for manufacturing multi-segment filter rods, comprising: a feeding unit for arranging, in a spaced relationship, rod-like elements in a train on a wrapper placed on a garniture belt; a filling unit for supplying a loose material to spaces between the rod-like elements; a cleaning unit for removing contaminations of the loose material from the rod-like elements; a garniture unit for wrapping the wrapper around the rod-like elements and the loose material to form a continuous rod; and a cutting head for cutting the continuous rod into multi-segment filter rods. The cleaning unit is the unit as described above.

There is also disclosed a method for cleaning, by removing contaminations of a loose material from rod-like elements, for use in machines in tobacco industry for manufacturing multi-segment filter rods, during a movement of a train comprising the rod-like elements separated by spaces filled with loose material and partially wrapped in a wrapper, the method comprising collecting the contaminations of the loose material from the rod-like elements by a suction nozzle. The method comprises the steps of: covering, by a covering element, at least partially the space filled with the loose material and not covered by the wrapper; removing the contaminations from the rod-like elements of the train of elements; and uncovering the previously covered part of the space.

The presented unit allows to manufacture filtering rods having compartments filled with loose material at a level close to 100%, which results in a high quality of the manufactured rods. An additional advantage is relatively low contamination of the machine for manufacturing the rods with loose material. Furthermore, the unit can operate at a high speed. Tests that have been performed have proven that the covering elements may be used to compress the loose material, in particular the loose material of a low bulk density that is problematic to fill the space between the rod-like elements.

### BRIEF DESCRIPTION OF FIGURES

The unit is shown by means of example embodiments in a drawing, in which:

FIGS. 1 and 2 show fragments of various examples of continuous multi-segment rods;

FIG. 3 shows an example of a multi-segment rod;

FIG. 4 shows schematically a fragment of a machine for manufacturing multi-segment filtering rods;

FIG. 5 shows a first embodiment of a cleaning unit;

FIG. 6 shows a second embodiment of the cleaning unit;

FIG. 7 shows an enlarged view of a region of covering a loose material;

FIG. 8 shows a third embodiment of the cleaning unit;

FIG. 9 shows a fourth embodiment of the cleaning unit;

FIG. 10 shows suction nozzles;

FIG. 11 shows the suction nozzles in a form of separate pipes;

FIG. 12 shows sliding covering elements.

FIG. 13 shows an embodiment of a covering element.

FIG. 14 shows a plurality of covering elements.

FIG. 15 shows another embodiment of the covering element.

### DETAILED DESCRIPTION

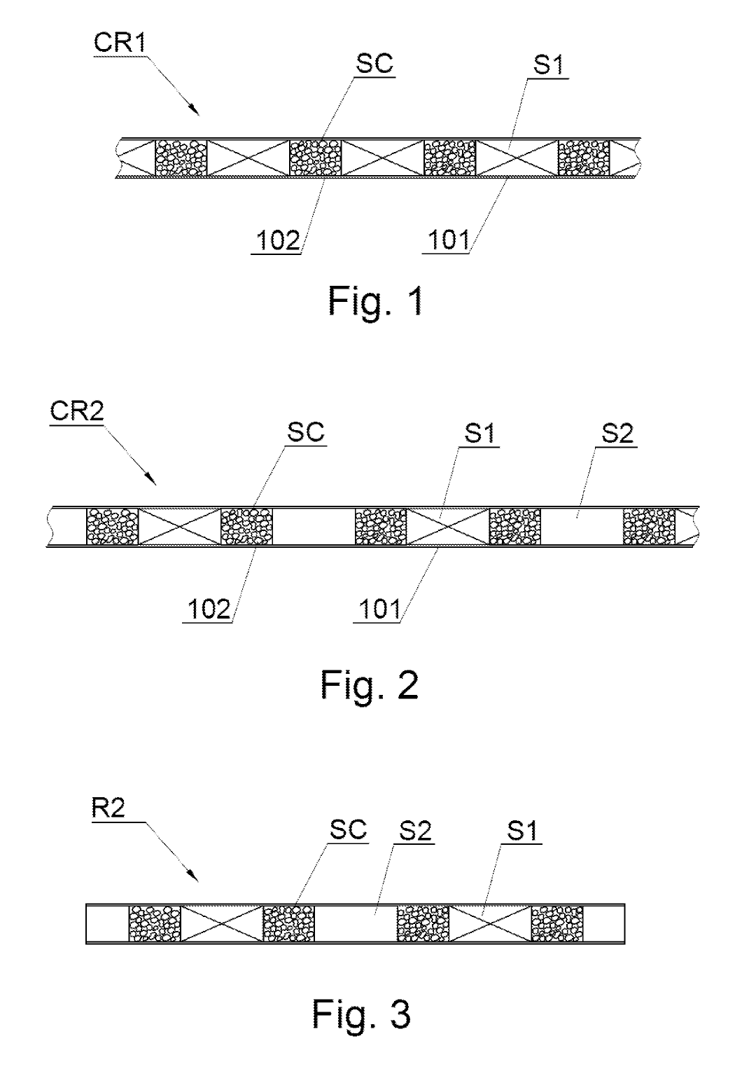

FIGS. 1 and 2 present fragments of various examples of continuous multi-segment rods CR1 and CR2 formed from a train of rod-like elements S1, S2 and SC formed by the presented unit, wherein the segments are wrapped in a wrapper 101. The segments S1 and S2 have a solid shape, typically cylindrical, whereas the segment SC is formed from a loose material 102 which is located between the segments S1 and S1 or between the segments S1 and S2. The presented continuous rods are cut into multi-segment rods. FIG. 3 shows an example of a multi-segment rod R2 formed from the continuous rod CR2.

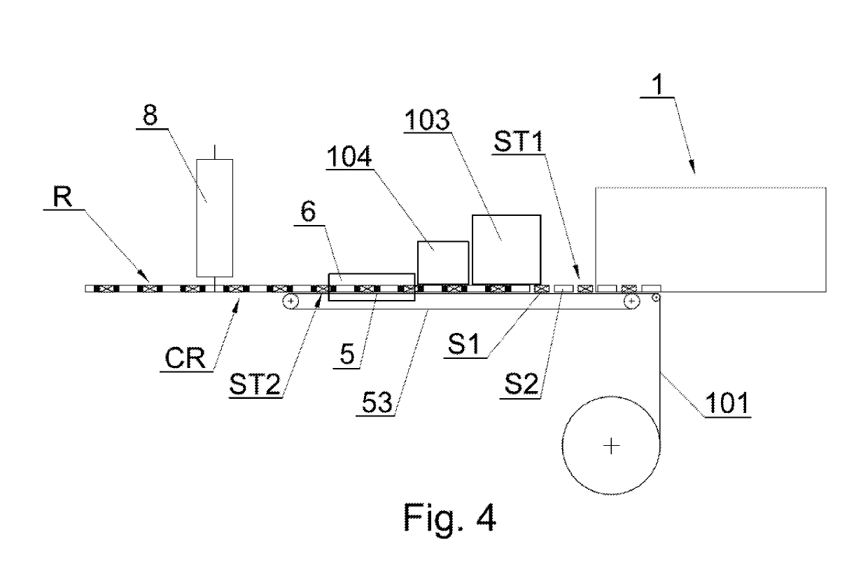

FIG. 4 shows schematically a fragment of a machine for manufacturing the multi-segment filtering rods. The machine comprises a feeding unit 1, which is configured to arrange the rod-like elements S1 and S2 as a train ST1, wherein the rod-like elements S1 and S2 are transported in a substantially preset spaced relationship. The rod-like elements S1 and S2 are fed to a garniture belt 5. A wrapper, such as a wrapping paper, is fed on a belt of the garniture belt 5 and the elements S1 and S2 are placed on the wrapper 101. The elements S1 and S2 received by the garniture belt 5 form a train ST2 of the rod-like elements S1 and S2, wherein the elements are arranged in a spaced relationship. Over the moving train ST1 there is located a filling unit for supplying the loose material, for example activated charcoal, in order to form the segment CS. Lifted edges of the wrapper 101 and front surfaces of the elements S1 and S2 form compartments, into which the loose material 102 is supplied from the filling unit 103. The train ST2 of the rod-like elements S1, S2 and CS that moves on the garniture belt 5 belt is wrapped in the wrapper 101 by a garniture unit 6, wherein the edges of the wrapper 101 are lifted before the final formation of the rod in the garniture unit 6. The garniture belt 5 typically forms a part of the garniture unit 6. Next to the filling unit 103 there is located a cleaning unit 104 for removing contamination from the rod-like elements i.e. particles of the loose material which fall on the surface of the rod-like elements S1 and S2 in the preceding step, i.e. when the loose material is supplied from the filling unit 103. The manufactured continuous rod CR is transported further and, after the wrapper 101 is glued in the garniture unit 6, it is cut by a cutting head 8 into individual multi-segment rods R.

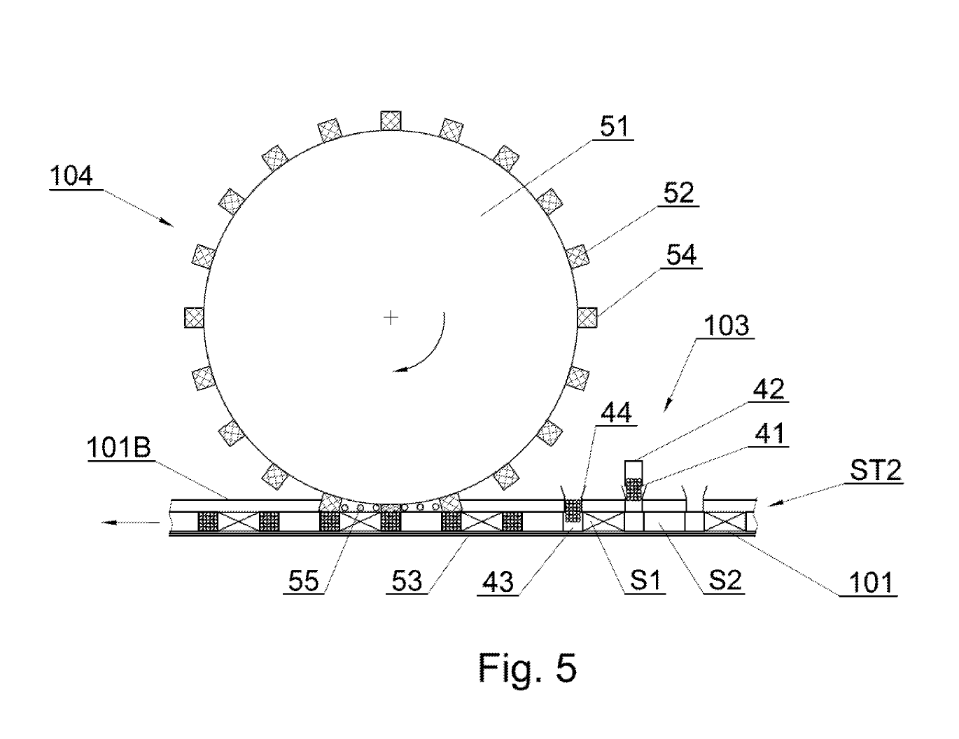

FIG. 5 shows a first embodiment of the cleaning unit 104. FIG. 5 also shows a fragment of the filling unit 103, wherein a portion of a loose material 41 located in a pocket 42 is placed in a space 43 between the elements S1 and S2, for example through a filling channel 44. Behind the filling unit 103 there is located the cleaning unit 104, comprising a wheel 51 having on its circumference a plurality of covering elements 52. A rotary motion of the wheel 51 is synchronized with the motion of a belt 53 of the garniture unit 6, on which the wrapper 101 is transported, with the train ST2 placed thereon. The cleaning unit 104 is arranged with respect to the garniture unit 6 such that pressing surfaces 54 of the covering elements 52 touch the loose material accumulated in the consecutive spaces 43 between the rod-like elements S1 and S2. Alternatively, the pressing surface 54 of the covering elements 52 may constitute an upper wall of the space 43 in case the space 43 is not entirely filled. The pressing surfaces 54 can be made of an air permeable or impermeable material, depending on the type of the loose material. The covering elements 52 are resilient, for example they may be made of a sponge-like material. The covering elements 52 may be used to compress the loose material. Furthermore, the cleaning unit 104 is equipped with suction elements supplying negative pressure to the zone in which the covering elements 52 have contact with the loose material or enclose the loose material. The suction elements may have a form of pipes or openings 55, for example made in a bar located in parallel to the direction of motion of the train ST2.

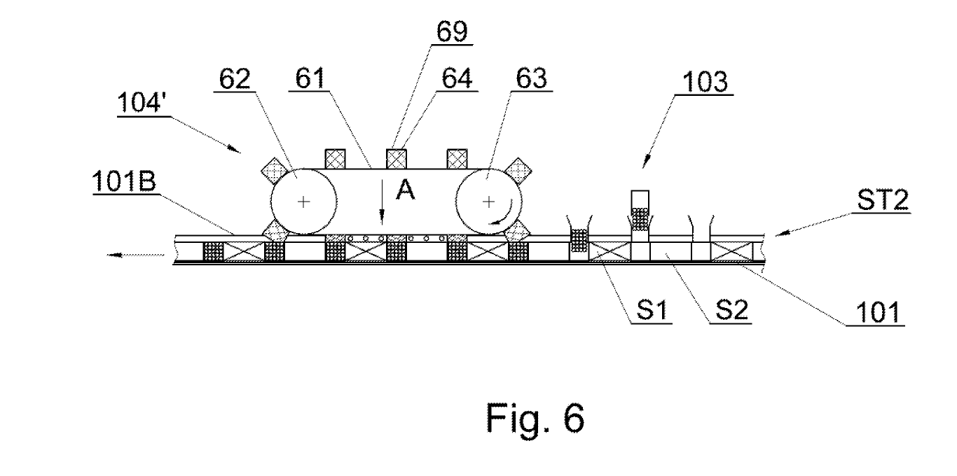

FIG. 6 shows a second embodiment of the cleaning unit 104′, comprising a belt 61 which is mounted on two wheels 62 and 63, with a plurality of covering elements 64 configured to cover the spaces 43 with the loose material by means of the pressing surfaces 69. The pressing surfaces 69 may have a shape of a concave portion of a cylinder.

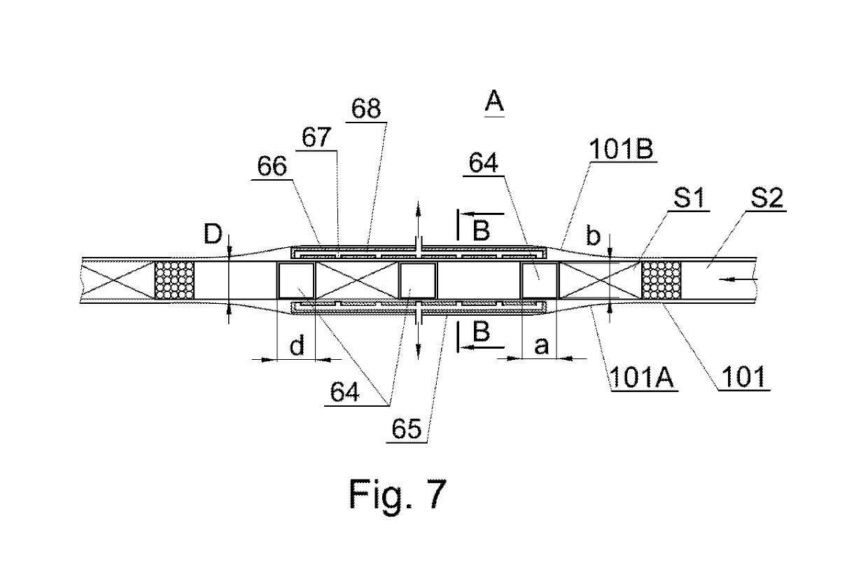

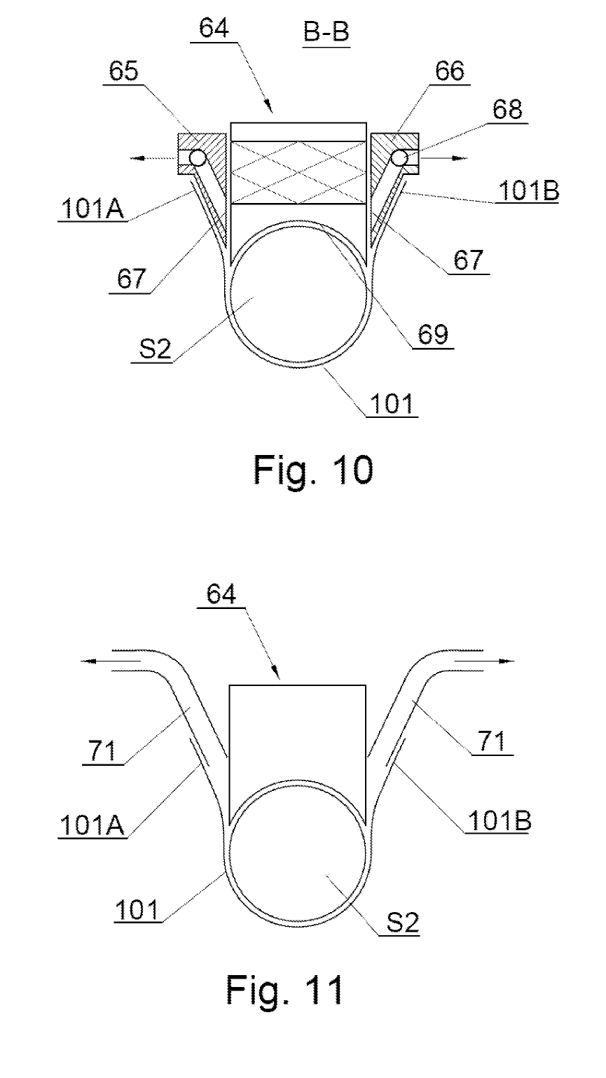

FIG. 7 shows an enlarged top view (with the belt 61 not shown for clarity) of a region of covering a loose material by the covering elements 64, and a region of removing contaminations (view A shown in FIG. 6). The covering element 64 has dimensions a and b, wherein the dimensions a and b are smaller than the distance d of the space between the rod-like elements S1 and S2 and the diameter D of the rod-like elements respectively, or equal to these dimensions. Alternatively, considering that the covering element 4 may be subject to deformations, it may be necessary to use the covering element having the dimensions a and b greater than the distance d and the diameter D respectively, in order to appropriately cover the space between the elements S1 and S2 after the deformation. The covering element 64 may be used to compress the loose material. The above remarks correspond to all embodiments. Along the region of covering the loose material, there are located suction nozzles 65 and 66 in a form of bars equipped with suction openings 67 and ducts 68 for supplying negative pressure. The suction nozzles 65 and 66 are shown in a cross-section B_B in FIG. 10. It is possible to use a plurality of neighboring suction nozzles, for example in a form of separate pipes 71 (as shown in FIG. 11). During the unit operation, edges 101A and 101B of the wrapper 101 (as shown in FIG. 7) are drawn aside outwards the suction nozzles 65 and 66 to enable access to the regions of the rod-like elements S1 and S2 where contaminations may accumulate.

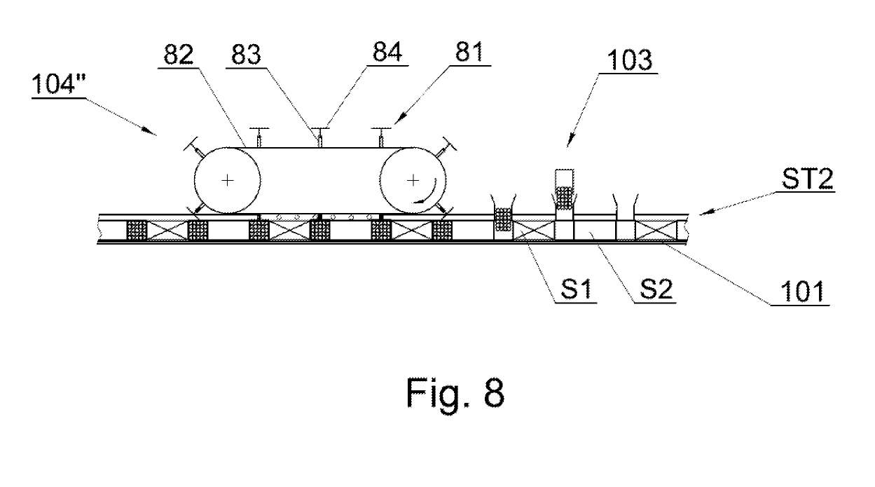

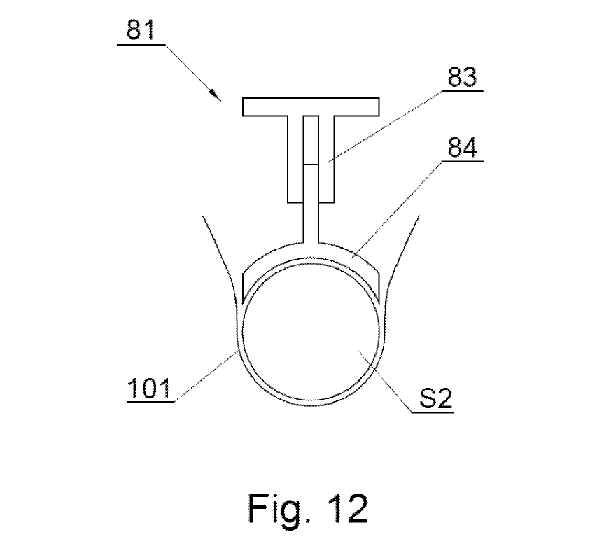

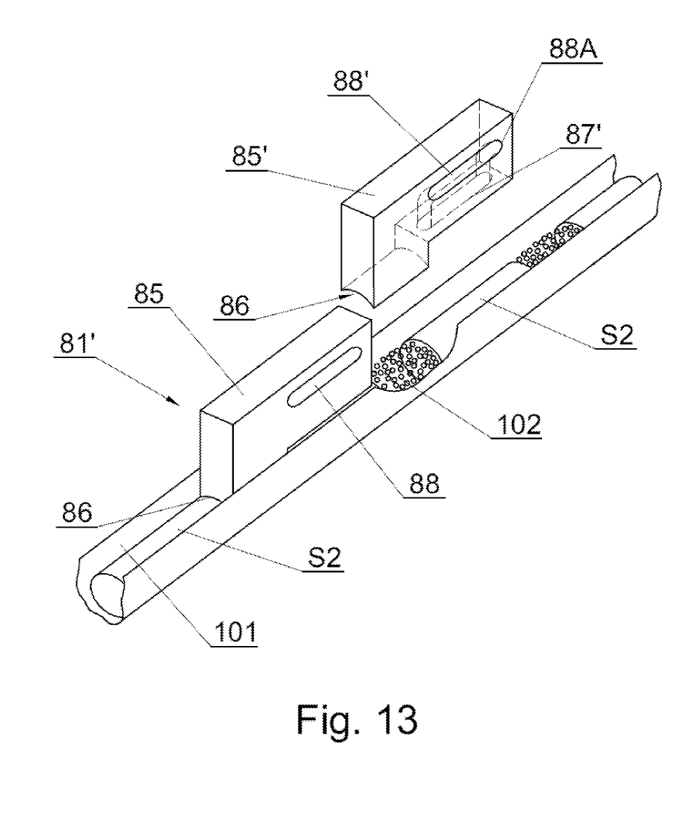

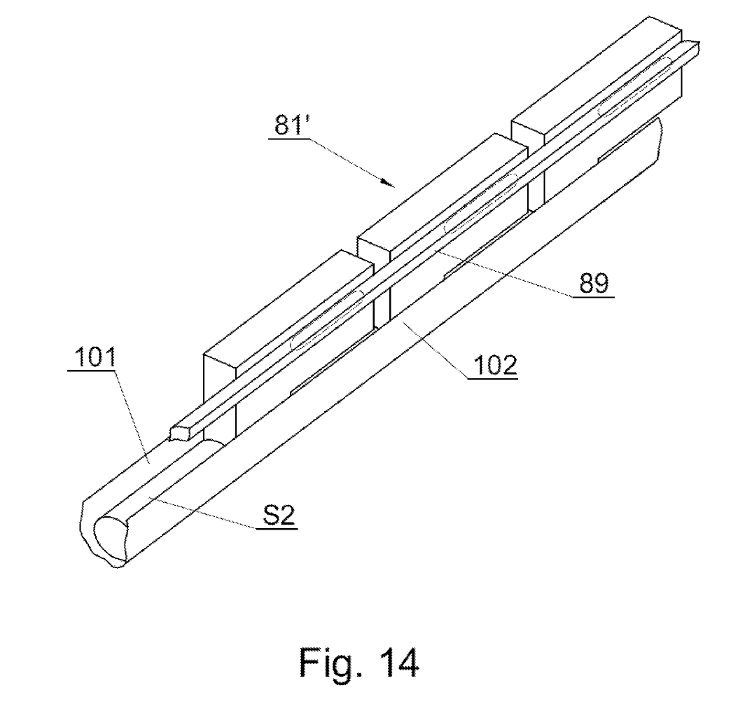

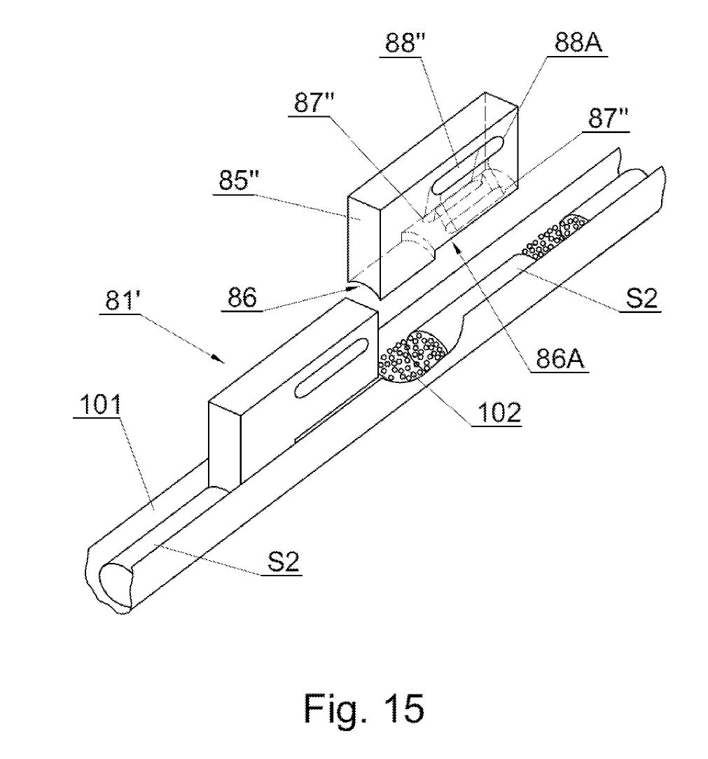

FIG. 8 shows a third embodiment of the cleaning unit 104″, wherein covering elements 81 are mounted, in a manner equivalent to the second embodiment, on a belt 82, whereas the covering elements 81 consist of two sliding elements 83 and 84 as shown in FIG. 12. FIG. 13 shows another embodiment of the covering element 81′, which may be used in the cleaning unit 104″ as shown in FIG. 8. The covering element 81′ has a form of a cube 85, a bottom surface 86 having a form of a concave cylinder surface adapted to cover the loose material 102 between the rod-like elements S2. The surface 86 may be used to compress the loose material 102. The cube 85 is shown in a working position, in which the surface 86 covers the loose material 102. The cube 85′ is shown in a position spaced from the loose material 102. The covering element 85′ comprises a duct 88′ ended at an opening 87′, through which the particles of the loose material which lie on the rod-like element S2 are drawn in. FIG. 14 shows a plurality of covering elements 81′, which move along the bar 89 comprising a plurality of suction nozzles which supply negative pressure to the ducts 88′ through the openings 88A. The bar 89 may be connected to the ducts 88′ of the covering elements 85′ by means of openings or a longitudinal duct in the bar on the side of the covering elements 85′. The negative pressure may be supplied to the bar 89 using various known methods. FIG. 15 shows another embodiment of the covering element 85″. The duct 88″ connected with the opening 88A splits and supplies the negative pressure through two openings 87″ made in a surface 86A. The surface 86A of the element 85′ or 85″ may be flat or cylindrically concave. In a position, in which the surface 86 covers the loose material, the surface 86A is located right next to the side surface of the rod-like element S2, and the openings 87″ are located above recesses between the paper wrapper 101 and the side surface of the rod-like elements S2. In case when the surface 86A is flat, it is possible for the surface 86A to touch the upper surface of the rod-like element S2. Preferably, there is a small space, at least 1.5 times bigger than the size of particles of the applied loose material, for example from 0.1 mm to 0.3 mm, between the upper surface of the rod-like element S2 and the lowest point of the surface 86A.

Similarly, openings such as the openings 87′, 87″ for receiving the loose material contaminations through a duct such as the ducts 88′ and 88″, may be comprised in the covering elements 52, 64, 84 of the other embodiments.

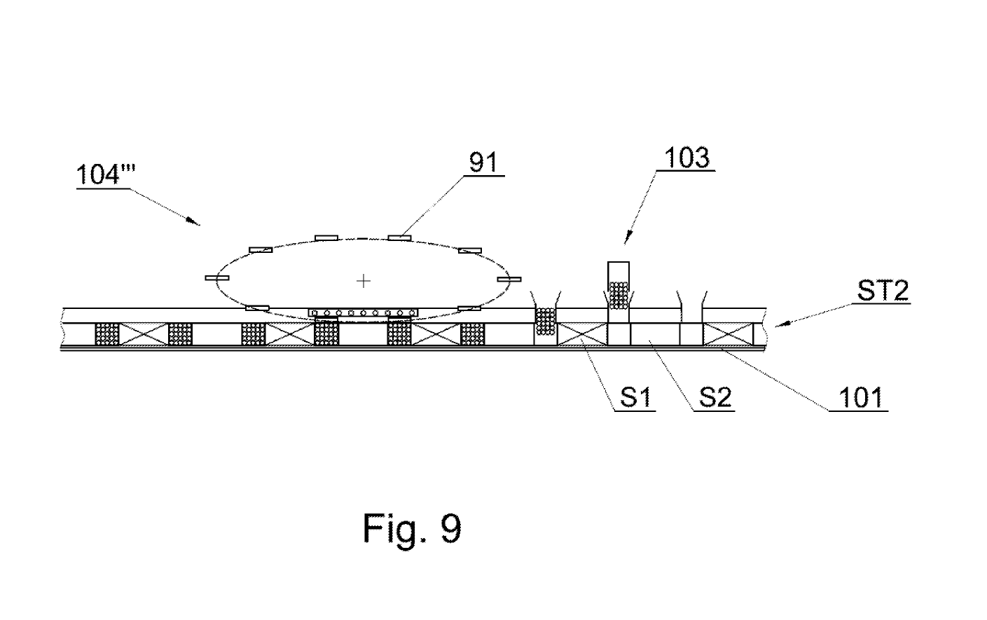

FIG. 9 shows a fourth embodiment of the cleaning unit 104′″, wherein covering elements 91 are mounted on a mechanism, in which ends of supports move on an elliptical track, wherein the horizontal arrangement of the covering elements 91 is maintained.

Other embodiments may comprise combinations of the elements of the embodiments described above.

1. A cleaning unit for machines used in tobacco industry, configured to remove contaminations of a loose material from rod-like elements arranged in a moving train, the moving train comprising rod-like elements separated with spaces filled with the loose material, the moving train being partially wrapped by a wrapper, wherein the cleaning unit comprises:
at least one suction nozzle for collecting the contaminations of the loose material from the rod-like elements, the cleaning unit further comprising a shifting mechanism configured to shift one or more covering elements to positions in which the one or more covering elements are to at least partially cover spaces filled with the loose material between the rod-like elements in a vicinity of the suction nozzle during movement of the moving train.

2. The cleaning unit according to claim 1, wherein the shifting mechanism comprises a wheel and the one or more covering elements mounted around a circumference of the wheel.

3. The cleaning unit according to claim 1, wherein the shifting mechanism comprises a belt and the one or more covering elements mounted on an outer surface of the belt.

4. The cleaning unit according to claim 1, wherein the shifting mechanism is configured to move the one or more covering elements along an elliptical track.

5. The cleaning unit according to claim 1, wherein the one or more covering elements are made of a resilient material.

6. The cleaning unit according to claim 1, wherein the one or more covering elements are mounted slidably with respect to the shifting mechanism of the one or more covering elements.

7. The cleaning unit according to claim 1, wherein the one or more covering elements comprise a pressing surface that is permeable to air.

8. The cleaning unit according to claim 1, wherein the one or more covering elements comprise a pressing surface that is impermeable to air.

9. The cleaning unit according to claim 1, wherein the one or more covering elements comprise a pressing surface in a shape of a portion of a cylinder.

10. The cleaning unit according to claim 1, wherein the one or more covering elements further comprise a surface with at least one opening for collecting the contaminations of the loose material through a duct in the one or more covering elements.

11. A machine for manufacturing multi-segment filter rods, comprising:
a feeding unit for arranging, in a spaced relationship, rod-like elements in a train on a wrapper placed on a garniture belt;
a filling unit for supplying a loose material to spaces between the rod-like elements;
a cleaning unit for removing contaminations of the loose material from the rod-like elements;
a garniture unit for wrapping the wrapper around the rod-like elements and the loose material to form a continuous rod; and
a cutting head for cutting the continuous rod into multi-segment filter rods, wherein
the cleaning unit is the cleaning unit according to claim 1.

12. A method for cleaning, by removing contaminations of a loose material from rod-like elements, for use in machines in tobacco industry for manufacturing multi-segment filter rods, during a movement of a train comprising the rod-like elements separated by spaces filled with loose material and partially wrapped in a wrapper, the method comprising collecting the contaminations of the loose material from the rod-like elements by a suction nozzle,
comprising:
in a vicinity of the suction nozzle, at least partially covering, by a covering element a space, of the spaces filled with the loose material, not covered by the wrapper;
removing the contaminations from the rod-like elements of the train comprising the rod-like elements by the suction nozzle; and
uncovering the least partially covered space.
